(19) United States
(12) Patent Application Publication
(10) Pub. No.: US 2025/0261659 A1
(43) Pub. Date: Aug. 21, 2025

(54) METHOD FOR MAKING PASTEURIZED IN-SHELL POACHED EGGS

(71) Applicant: Aegis Foods LLC, South Holland, IL (US)

(72) Inventors: Jay Berglind, Riverside, IL (US); Lionel Valencia, Lansing, IL (US); Erdogan Ceylan, Orland Hills, IL (US); Joseph Vincent Berglind, Riverside, IL (US); Javier Antunes, Lansing, IL (US)

(73) Assignee: Aegis Foods LLC, South Holland, IL (US)

(21) Appl. No.: 19/053,748

(22) Filed: Feb. 14, 2025

Related U.S. Application Data
(60) Provisional application No. 63/553,758, filed on Feb. 15, 2024.

(51) Int. Cl. A23B 5/005; A23B 5/01; A23L 5/10; A23L 15/00

(52) U.S. Cl. CPC A23B 5/0052; A23B 5/01; A23L 5/13; A23L 15/00

(57) ABSTRACT

Two stage heated water treatment of shell eggs results in-shell poached eggs. The in-shell poached are sufficiently cooked so when the eggs are cracked onto a plate the eggs have the characteristics of conventional poached eggs without further cooking and need only to be warmed for consumption. The in-shell poached eggs are also pasteurized in the shell to meet the FDA and WHO requirement of a 5-log reduction of Salmonella Enteritidis.

### CROSS-REFERENCE TO RELATED APPLICATION

The present application claims priority of U.S. Provisional Patent Application No. 63/553,758, filed Feb. 15, 2024, the content of which is incorporated herein by reference in its entirety.

### FIELD OF THE INVENTION

In one aspect, the invention relates to a method of making in-shell poached shell eggs, in particular pasteurized in-shell poached eggs. The pasteurized, in-shell poached eggs are typically refrigerated, shipped and distributed to a final destination where the eggs are warmed and cracked for consumption.

### BACKGROUND OF THE INVENTION

A poached egg is an egg that has been cooked outside the shell, normally cracked and dropped in simmering water for several minutes so that the egg white or albumen is firm, and the yolk is warmed but remains in liquid form. The yolk is desirably covered in a white pocket. Sometimes the cracked egg is placed in a small bowl before setting the raw egg into simmering water. It is preferred to simmer the water at e.g., 160-170° F., below the temperature required to boil the water. Sometimes poached eggs are prepared in a shallow pan, and the simmering water is spooned over the cracked egg.

Poaching eggs can yield more delicately cooked eggs than cooking at higher temperatures such as with boiling water. Poached eggs are a classic breakfast staple loved by many for their delicate texture and rich flavor. However, achieving a perfectly poached egg can be a daunting task even for experienced cooks. Differences in egg size and composition require different cooking times even if the water temperature is tightly controlled, which is not often the case especially when poaching several eggs at a time. Also, whether the eggs are refrigerated or brought up to room temperature before poaching can influence the cooking time and the end result. In food service applications, the total process of preparing poached eggs normally takes 5 to 8 minutes (e.g., about 4 minutes of cooking time) and requires a cook to monitor the process to avoid overcooking or undercooking. Not surprisingly, preparing poached eggs often results in higher waste and longer prep time, since it is common to overcook, undercook or break poached eggs during preparation. In addition, sometimes the outer albumen is wispy when cooked which many find not desirable in terms of texture and presentation. Older raw eggs tend to have runnier albumens, so wispy poached eggs tend to be more of an issue when using older eggs. Some cooks use vinegar to change the acidity of water and its effect on coagulation, which has been found to help reduce wispiness. Sometimes runny albumen is strained away from the raw egg prior to poaching in order to avoid wispiness. Also, clean up is particularly important especially in food service kitchens using unpasteurized shell eggs to avoid Salmonella contamination, and any bowls or utensils in contact with raw egg needs to be kept separate from prepared food product served to customers.

The purpose of pasteurizing shell eggs is to kill pathogens that may be within the egg, namely Salmonella Enteriditis and other forms of Salmonella. Fully cooking unpasteurized eggs, such as preparing fully cooked scrambled eggs, removes the risk of Salmonella in the cooked eggs. However, unpasteurized shell eggs cooked to retain a liquid yolk, such as poached eggs, sunny side up eggs, over easy eggs or soft-boiled eggs, may present a risk of Salmonella. Further, using unpasteurized shell eggs in a kitchen introduces exposure risk from the dishes, utensils, counters, sinks and other items that may be in contact with the egg prior to cooking or even in contact with undercooked portions of the prepared egg. While residential kitchens can benefit from the use of pasteurized shell eggs, commercial food service establishments have generally recognized the safety and economic benefit of using pasteurized shell eggs.

There are theoretically different ways to kill or eliminate Salmonella from shell eggs, but current commercial processes heat the shell egg such that the entire egg including the center of the egg yolk warms to an adequate temperature for a sufficient amount of time to meet or exceed the accepted standard for reduction of Salmonella Enteritidis set by the FDA, which is a 5-log reduction of Salmonella. A 5-log reduction of Salmonella Enteritidis is the regulated standard set by the FDA (Food and Drug Administration) and WHO (World Health Organization) for pasteurization of in-shell chicken eggs. It is critical that sufficient heat be provided to meet the 5-log reduction standard throughout the entire mass of the egg, in as much as the D-value (e.g., statistical time to kill one log of Salmonella) in egg yolk is longer than in egg albumen for a given temperature.

### SUMMARY OF THE INVENTION

In one aspect, the present invention pertains to shell eggs that are sufficiently cooked so when the eggs are cracked onto a plate the eggs have the characteristics of poached eggs without further cooking and need only to be warmed for consumption. Preferably, the shell eggs are also pasteurized in the shell to meet the FDA and WHO requirement of a 5-log reduction of Salmonella Enteritidis.

Applicant has developed a continuous feed, shell egg pasteurization system which is disclosed in co-pending Ser. No. 18/960,352, filed Nov. 26, 2024, entitled “Continuous Feed, Horizontal Water Spray Shell Egg Pasteurization System,” by Berglind, et al. and is incorporated herein by reference. Applicant has modified the operation of the system disclosed in the co-pending application to produce pasteurized, in-shell poached eggs. The pasteurizer sprays heated water on shell eggs that are moved through a tunnel on a conveyor and rotated as the heated water is sprayed on the eggs. While other means of heating the shell eggs may be suitable to implement the invention, Applicant has found that the described spray heating process is particularly consistent and repeatable, and when operated in accordance with the preferred protocol produces “in-shell poached eggs” having consistent high quality.

This application uses the terminology “in-shell poached eggs” to describe the shell eggs that are sufficiently cooked in the shell so when the eggs are cracked onto a plate the eggs have the characteristics of poached eggs without further cooking, only needing to be warmed for consumption. Applicant's “in-shell poached eggs” are not cooked by cracking raw or pasteurized eggs into simmering water, like conventional poached eggs. Applicant's eggs are cooked, pasteurized and distributed in the shell. It is preferred to warm the eggs in their shells and then crack the warmed eggs for consumption.

The preferred method of producing the pasteurized in-shell poached eggs involves a multiple-temperature process (e.g., first 134.5° F. and then 160° F.), where the shell eggs are initially heated to a temperature that is not intended to coagulate the albumen but bring the albumen and the yolk above 128° F., which is the minimum temperature for pasteurization according to FDA rules. After initial heating, the temperature of the water spray is increased substantially over a normal pasteurization temperature for a given length of time to sufficiently cook and coagulate the albumen and also ensure the yolk is fully pasteurized but not coagulated. To make the in-shell poached egg, it is important to not overcook the albumen, which results in a soft-boiled or a jammy egg. By selecting the proper time and temperature of each phase of the process, it is possible to produce an in-shell poached egg as shown for example in FIG. 7. When cracked on a plate the yolk sits in the pocket of albumen with a thin film of egg white covering the yolk, resembling a typical poached egg. Of course, after pasteurization and cooking at the plant, the in-shell poached eggs are refrigerated prior to and during distribution. To prepare the in-shell poached eggs for consumption, the eggs are warmed preferably in the shell and then cracked open, but there is no need to further cook the eggs for consumption. There are several methods of heating the in-shell poached eggs, including heating multiple eggs in the shell in water at a low temperature (e.g., sous vide 130° F.) for up to four hours so that the eggs are ready to use on demand, or heating in skillet with steam or short term in simmering water, or even in a microwave. It is preferred to warm the in-shell poached eggs in the shell, but the eggs can be warmed after being cracked open if desired.

Although not a preferred process, Applicant has verified that in-shell poached eggs as described above can also be prepared by placing raw unpasteurized shell eggs in a first water bath held at a first temperature (e.g. 134.5 F) for a first predetermined time duration (e.g., 18 minutes), and then moved to a second water bath held at a second temperature (e.g. 160 F) for a second predetermined time duration (e.g., 6 minutes).

It is believed that the initial pasteurizing step at e.g., 134.5° F. for 18 minutes causes proteins in the inner albumen to begin crosslinking and stiffen while the outer albumen does not react or does not react as much in this step of the process. Then, in the second step at e.g., 160° F. for 6 minutes both the inner and the outer albumen become sufficiently coagulated and whiten. The result is that the eggs resemble a normal poached egg when cracked onto a plate or toast.

### BRIEF DESCRIPTION OF THE DRAWINGS

FIG. 1 is a plot of water bath time and temperature for one method of heat-treating shell eggs to make pasteurized, in-shell poached shell eggs.

FIG. 2 is a plot of yolk temperature inside shell eggs heat treated in accordance with the method depicted in FIG. 1.

FIG. 3 is a top plan view of a continuous feed, water spray shell egg heat treating system constructed in accordance with an exemplary embodiment of the invention.

FIG. 3A is a detailed view of the section labelled 3A-3A in FIG. 1, showing the intake assembly and the first heat treating zone.

FIG. 3B is a detailed view of the section labelled 3B-3B in FIG. 1, showing the outlet and the final heating treating zone.

FIGS. 4A and 4B show a side elevational view of the continuous feed, water spray shell egg heat treating system shown in FIG. 3.

FIG. 4A shows the intake assembly and the first heat treating zone zone.

FIG. 4B shows the outlet and the final heat-treating zone.

FIG. 5 is a schematic cross section illustrating a preferred spray pattern in the heat treatment system of FIG. 3.

FIG. 5A shows the overlapping spray pattern from above the conveyor.

FIG. 5B is a detailed view illustrating the overlapping spray pattern.

FIG. 6 is a heating system layout for heating recycled and makeup water to a selected temperature for spraying.

FIG. 7 is a photograph of a cracked, in-shell poached egg that had been heat treated using a continuous feed, water spray shell egg heat treating system as described in Example 2.

FIG. 8 is a photograph of in-shell poached eggs being warmed in shell using a sous vide method.

FIG. 9 is a photograph of a cracked, in-shell poached egg after it has been warmed in the shell and cracked onto a plate.

FIG. 10 is a photograph of exemplary warmed, in-shell poached eggs cracked into a bowl and cut open to show running yolks.

### DETAILED DESCRIPTION

As described above, in one aspect, the invention pertains to a method of making pasteurized, in-shell poached eggs. As explained above, the terminology “in-shell poached eggs” is used herein to describe the shell eggs that are sufficiently cooked in the shell so when the eggs are cracked onto a plate the eggs have the characteristics of poached eggs without further cooking. Applicant's “in-shell poached eggs” are not cooked by cracking raw or pasteurized eggs into simmering water, like conventional poached eggs. Applicant's eggs are cooked, pasteurized, and distributed in the shell. It is preferred to warm the eggs in their shells and then crack the warmed eggs for consumption, although some may desire to crack the eggs prior to warming them to serve.

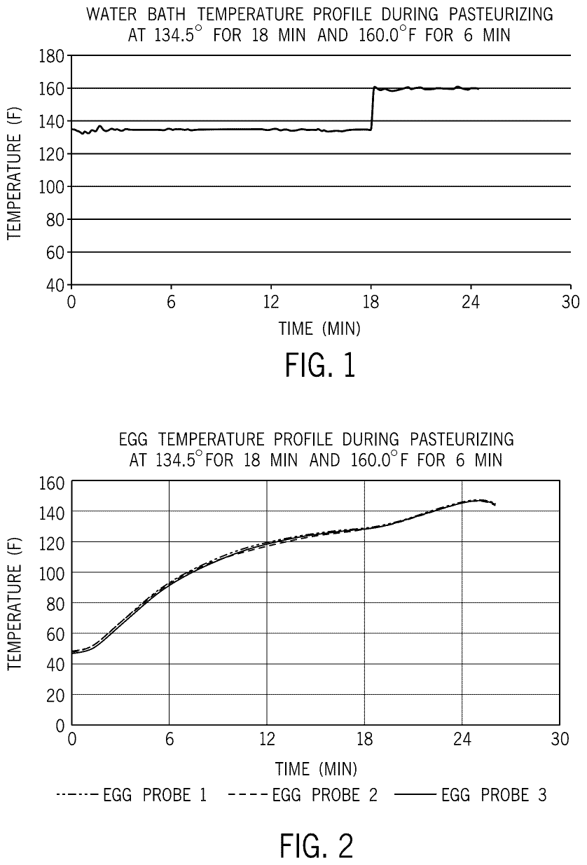

Two different methods of processing pasteurized, in-shell poached eggs are described below in connection with Examples 1 and 2. Example 1 describes the steps taken to verify that shell eggs treated with heated water in accordance with the invention are pasteurized properly. FIGS. 1 and 2 show the preferred time and temperature for the heat treatment to properly pasteurize the shell eggs and still result in shell eggs cooked sufficiently to have the texture and consistency of a normal poached egg when cracked onto a flat surface, only needing to be warmed for consumption. In Example 1, the heat treatment is applied with two water baths. The first water bath holds water at a first temperature, such as 134.5° F., which does not coagulate the yolk and is unlikely to coagulate the albumen if held in the water bath for 18 minutes. The shell eggs are desirably held in the first water bath long enough to raise the temperature of the yolk above the minimum threshold for pasteurization (128° F.), without substantially cooking the albumen. The shell eggs are then held in the second water bath which is held at a higher temperature for an appropriate time to cook but not overcook the albumen in the shell such that when cracked onto a plate the shell egg resembles a typical poached egg. The time and temperature of the second water bath is also selected so that the overall process results in a 5-log reduction of Salmonella throughout the entire egg. FIG. 2 shows the temperature of the yolk of a representative shell egg during the two-stage process (134.5° F. for 18 minutes, and 160.0° F. for six minutes), and it has been verified that this process provides the required 5 log reduction of Salmonella Enteriditis to pasteurize the shell eggs according to FDA standards.

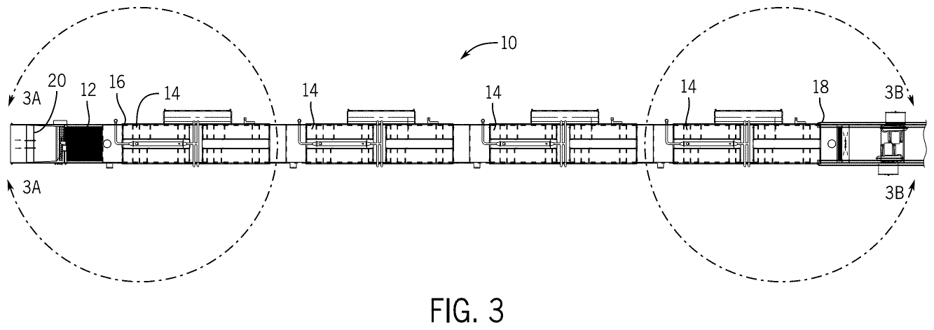

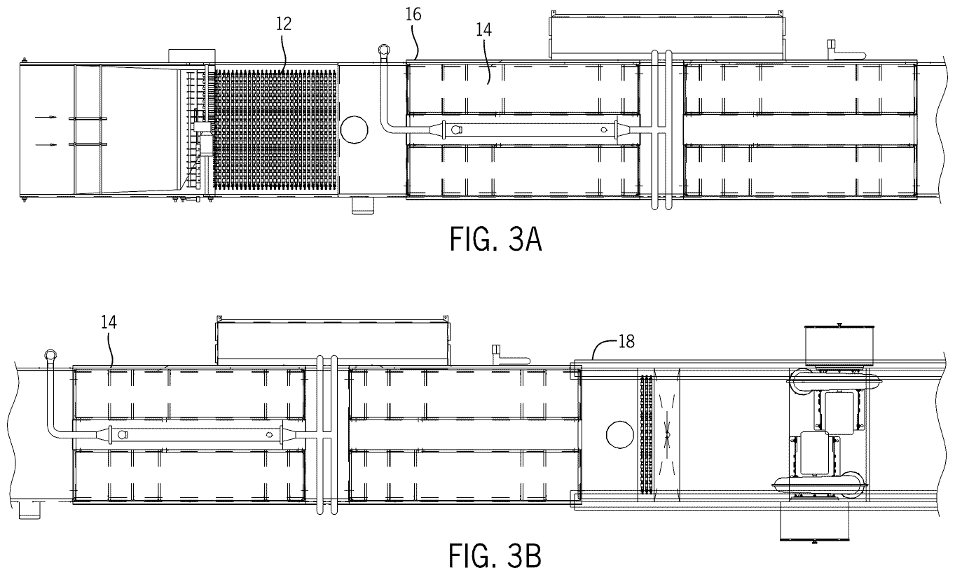

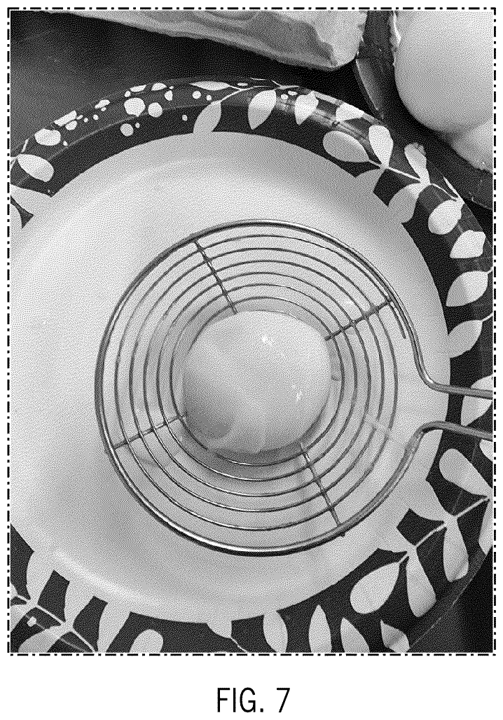

Example 2 describes a method of making pasteurized, in-shell poached eggs on a commercial scale using the continuous feed, water spray shell egg heat treatment system described in FIGS. 3 through 6. A photograph of pasteurized, in-shell poached eggs prepared according to the process described in Example 2 are shown in FIG. 7 through 9.

### Example 1—Pasteurized In-Shell Poached Egg (Water Baths)

Applicant has prepared pasteurized, in-shell poached eggs and validated a water heating process to demonstrate scientific evidence for a 5-log reduction of Salmonella. In this process, inoculated USDA Large eggs were treated with hot water at 134.5° F. for 18 min and then at 160° F. for 6 min. Counts of Salmonella were determined before (i.e., inoculated untreated control) and after treatment (i.e., inoculated hot water pasteurized samples). Pasteurization of USDA Large shell eggs at 134.5° F. for 18 min and 160° F. for 6 min achieved greater than the required 5-log reduction of Salmonella.

Tests were run using five dozen raw, unpasteurized USDA Large shell eggs that were refrigerated at 45° F. The following six strains of Salmonella maintained in Silliker Food Science Center (FSC) culture collection (FSC-CC) were used in this study: Salmonella Enteritidis 267 (CDC: 134-87), 268 (CDC: 154-87), 269 (CDC 48-86); Salmonella Heidelberg 539; Salmonella Othmarschen 544; Salmonella Typhimurium449 (ATCC 14028, tissue from 4-week old chickens. The purity of each strain of Salmonella was verified by streak plating on xylose lysine desoxycholate (XLD) agar. The plates were incubated for 24 h at 35° C. Typical colonies were considered confirmatory.

Strains of Salmonella were cultivated in tryptic soy broth (TSB) on two consecutive days and incubated at 35° C. for 24 h. The cultures were mixed to prepare a composite culture that contains approximately equal numbers of cells of each strain. The composite culture was centrifuged at 7,000 rpm for 15 min, the supernatant discarded, and the bacterial pellet suspended in yolk (1:10 wt/wt).

A small hole was made in the shell of each egg where the air sac is located. A 2.5 inch, 20-gauge syringe needle with a 1 cc syringe (BD, Franklin Lakes, NJ) was used to inject 0.1 ml of composite culture into the yolk of each egg. The hole was sealed subsequently with a sealant (SEAL ALL, Eclectic Products, Pineville, LA) and set for 15 minutes or longer at the pre-conditioning temperature of 45° F. (7° C.) for bacterial attachment. The egg yolk was inoculated with the composite culture of Salmonella.

The temperature of the water baths was monitored using Yokagawa portable hybrid recorder (Shenandoah, GA) with T-type thermocouples. The temperature of shell eggs was monitored using Artificial Egg (MadgeTech, Warner, NH), which have been validated to accurately monitor yolk temperature during hot water treatment, see Table 3 below.

Inoculated eggs were placed in metal cages, fully submerged in hot water and subjected to a thermal treatment at 134.5° F.±0.5° F. for 18 min and 160.0° F.±0.5° F. for 6 min in temperature-controlled circulating water baths. Treated samples were pulled at pre-determined time intervals for analysis. The water baths were pre-warmed to test temperatures. Thermal treatment parameters and time intervals for sampling pasteurization (thermal treatment) parameters and sampling intervals were as follows (Table 1). Five replicate samples were analyzed per time interval.

TABLE 1
Pasteurization parameters and time intervals for treatments

| | |
|---|---|
| Pull times | Inoculated control (untreated) |
| | After 18 min at 134.5° F. and 5:30 min:sec at 160° F. |
| | (30 sec before end of Zone 4) |
| | After 18 min at 134.5° F. and 5:45 min:sec at 160° F. |
| | (15 sec before end of Zone 4) |
| | After 18 min at 134.5° F. and 6 min at 160° F. |
| | (End of Zone 4) |
| | After 18 min at 134.5° F. and 6:15 min:sec at 160° F. |
| | (15 sec after end of Zone 4) |
| | After 18 min at 134.5° F. and 6:30 min:sec at 160° F. |
| | (30 sec after end of Zone 4) |

Thermally processed and control eggs were soaked for 5 min in 70% ethanol. The eggs were then blotted dry and cracked opened. The yolk was separated from the white and analyzed. The yolk was blended with 9 volumes of Butterfield's phosphate diluents in a Stomacher lab blender to form a 1:10 homogenate. Tenfold serial dilutions were prepared with the Butterfield's phosphate diluents.

Samples were analyzed by the pour plate technique. Aliquots from the stomacher bag and the subsequent dilutions were pipetted into sterile petri dishes. Approximately 15-ml of nonselective trypticase soy agar (TSA) tempered at 45° C. were poured into the petri dishes and swirled to mix well. Plates were stored at ambient temperature for up to 2-4 h to resuscitate injured cells. A thin layer (10 ml) of selective media, xylose lysine desoxycholate (XLD) for Salmonella was poured onto solidified nonselective agar. Plates were allowed to solidify at ambient temperature for approximately 30 min. The agar plates were incubated aerobically using Trypticase soy agar with xylose lysine deoxycholate overlay for 48 h at 35° C. Uninoculated (negative) control was analyzed for aerobic plate counts, see Table 2.

Temperature profiles of the eggs and water bath during pasteurization are given in FIGS. 1 and 2. Internal egg temperatures are presented in Table 2. Average temperatures of hot water were 134.66° F. (+0.46) for the first 18 min) and 159.90° F. (+0.36) for the final (i.e. last 6.5 min including 0.5 min to collect addition samples). Microbiological test results are given in Table 2.

Inoculation level was 6.81 log CFU/g in yolk. After treatments, the counts of Salmonella were reduced below the detection limit of 1 CFU/g in yolk. Average reduction value was>6.81 log CFU/g in yolk for all treatment times. Aerobic plate counts (i.e., natural microflora) of yolk in uninoculated eggs were below 10 CFU/g. In conclusion, heat treating large shell eggs at 134.5° F.±0.5° F. for 18 min and 160.0° F.±0.5° F. for 6 min achieved greater than the desired 5-log reduction of Salmonella.

TABLE 2
Counts of Salmonella in inoculated samples before and after pasteurizing
at 134.5° F. for 18 min and 160.0° F. for 6 min

| | Salmonella counts in yolk | | | |
|---|---|---|---|---|
| | | | log | Average log |
| | Replicate | CFU/g | CFU/g | reduction |
| Inoculated untreated | 1 | 6100000 | 6.79 | |
| (positive) control | 2 | 6400000 | 6.81 | |
| | 3 | 7800000 | 6.89 | |
| | 4 | 6700000 | 6.83 | |
| | 5 | 5300000 | 6.72 | |
| | Average | | 6.81 | |
| After 18 min at 134.5° F. | 1 | <1 | <0.0 | >6.81 (±0.06) |
| and 5:30 min:sec at 160° F. | 2 | <1 | <0.0 | |
| (30 sec before 6 min)* | 3 | <1 | <0.0 | |
| | 4 | <1 | <0.0 | |
| After 18 min at 134.5° F. | 1 | <1 | <0.0 | >6.81 (±0.06) |
| and 5:45 min: sec at 160° F. | 2 | <1 | <0.0 | |
| (15 sec before 6 min) | 3 | <1 | <0.0 | |
| | 4 | <1 | <0.0 | |
| | 5 | <1 | <0.0 | |
| After 18 min at 134.5° F. | 1 | <1 | <0.0 | >6.81 (±0.06) |
| and 6 min at 160° F. | 2 | <1 | <0.0 | |
| | 3 | <1 | <0.0 | |
| | 4 | <1 | <0.0 | |
| | 5 | <1 | <0.0 | |
| After 18 min at 134.5° F. | 1 | <1 | <0.0 | >6.81 (±0.06) |
| and 6:15 min:sec at | 2 | <1 | <0.0 | |
| 160° F. (15 sec after 6 | 3 | <1 | <0.0 | |
| min) | 4 | <1 | <0.0 | |
| | 5 | <1 | <0.0 | |
| After 18 min at 134.5° F. | 1 | <1 | <0.0 | >6.81 (±0.06) |
| and 6:30 min:sec at 160° | 2 | <1 | <0.0 | |
| (30 sec after 6 min) | 3 | <1 | <0.0 | |
| | 4 | <1 | <0.0 | |
| | 5 | <1 | <0.0 | |

*Four replicate samples were analyzed due to a cracked egg

As mentioned, the temperature of shell eggs was monitored using Artificial Egg sensors (MadgeTech, Warner, NH), which have been validated to accurately monitor yolk temperature during hot water treatment. The results are shown in Table 3. It can been seen that it takes roughly 18 minutes in water at 134.5° F. for the yolk to come up to 128° F. Then, when placed in the second water bath at 160° F., the temperature of the yolk increases to about 145° F. at minute 24 (18 minutes at 134.5 and 6 min at 160).

TABLE 3
Temperature profile of large shell egg (artificial egg) when heat treated in
hot water at 134.5° F. for 18 min and 160.0° F. for 6 min

| | Egg temperature (° F.) | | |
|---|---|---|---|
| | Egg probe | Egg Probe | Egg Probe |
| Time (min) | 1 | 2 | 3 |
| 0.00 | 47.88 | 47.52 | 47.34 |
| 1.00 | 50.58 | 50.4 | 49.5 |
| 2.00 | 57.96 | 58.14 | 56.34 |
| 3.00 | 67.68 | 67.32 | 65.88 |
| 4.00 | 77.22 | 76.32 | 75.24 |
| 5.00 | 85.68 | 84.42 | 83.88 |
| 6.00 | 92.88 | 91.62 | 91.44 |
| 7.00 | 99.18 | 97.92 | 98.1 |
| 8.00 | 104.58 | 103.32 | 103.5 |
| 9.00 | 109.08 | 107.82 | 108.36 |
| 10.00 | 113.04 | 111.78 | 112.32 |
| 11.00 | 116.28 | 115.02 | 115.74 |
| 12.00 | 119.16 | 117.9 | 118.62 |
| 13.00 | 121.32 | 120.24 | 120.96 |
| 14.00 | 123.48 | 122.4 | 123.12 |
| 15.00 | 125.1 | 124.02 | 124.74 |
| 16.00 | 126.36 | 125.64 | 126.18 |
| 17.00 | 127.44 | 126.72 | 127.44 |
| 18.00 | 128.52 | 127.98 | 128.34 |
| 19.00 | 130.32 | 129.78 | 130.14 |
| 20.00 | 133.2 | 132.84 | 133.02 |
| 21.00 | 136.62 | 136.26 | 136.44 |
| 22.00 | 139.86 | 139.5 | 139.68 |
| 23.00 | 142.74 | 142.2 | 142.56 |
| 24.00 | 145.26 | 144.72 | 145.08 |
| 25.00 | 147.06 | 146.16 | 146.88 |

### Example 2—Pasteurized In-Shell Poached Egg (Continuous Feed, Water Spray System)

The objective in this example was to assess the ability to replicate the lethality of the pasteurization process described in the Example 1 using a modified protocol for operating the pasteurization system disclosed in previously incorporated co-pending Ser. No. 63/603,151, entitled “Continuous Feed, Horizontal Water Spray Shell Egg Pasteurization System,” by Berglind, et al. In particular, the system 10 is operated as follows: Zones 1-3 spray temperature of 134.5° F. for 6 minutes in each of the three zones and Zone 4 spray temperature of 160° F. for 6 minutes.

FIGS. 3, 3A-B, and 4A-B illustrate a shell egg spray bath heat treatment system 10 in which shell eggs are continuously transported through a horizontal tunnel 14 and rotated on a conveyor 12 moving through four zones (Zones 1 through 4). Each of the zones sprays heated water on the rotating shell eggs at prescribed temperatures to heat the yolk of each shell egg suitable for pasteurization, and to also sufficiently cook the albumen to produce in-shell poached eggs as previously described. FIG. 7 illustrates cracked pasteurized, in-shell poached shell eggs that have been pasteurized and cooked in the system 10 of FIGS. 3, 3A-B, and 4A-B.

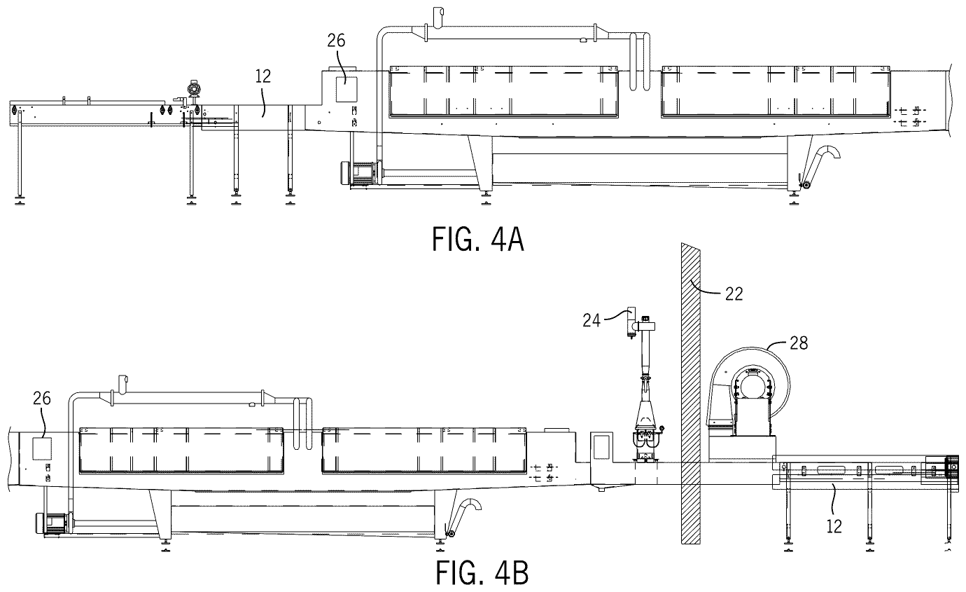

Referring still to FIGS. 3, 3A and 4A, the conveyor 12 extends in the horizontal tunnel 14 through all four zones 1-4. Each zone is approximately 25 feet long, and the conveyor 12 runs through approximately 100 feet of tunnel 14. The conveyor 12 is approximately 5 feet in width and holds eighteen (18) shell eggs across per row. The inlet 16 to the tunnel 14 is on the left-hand side of FIG. 3 and the outlet of the tunnel 18 is on the right-hand side of FIG. 3. Unpasteurized shell eggs are loaded onto an intake table 20 upstream of the inlet 16 to horizontal tunnel 14. An automated loader loads the eggs onto an intake table 20 which steers the shell eggs onto the conveyor 12 upstream of the tunnel inlet 16 as is known in the art.

The shell eggs are transported on conveyor 12 through zones 1-4 in which they are heat treated and are discharged from the tunnel exit 18. FIG. 4B shows a wall 22 through which the conveyor 12 extends downstream of the pasteurizer 10. Downstream of the wall 22 defines a post pasteurization side of facility. FIG. 4 shows an optional sanitizer applicator 24 on the raw side of wall 22. The sanitizer applicator 24 dispenses a quaternary solution to treat the shell eggs after they have passed through the tunnel 14. Each zone of the system has a dedicated electrical junction box 26, and each zone also has a dedicated plumbing loop that provides heated water to the spray nozzles and also collects used water for recycling and re-heating.

Referring still to FIG. 4B, a dryer 28 is located downstream of the wall 22 that separates the post-pasteurization side of the facility from raw side of the facility. The conveyor 12, or another conveyor moves the shell eggs through the dryer 28 for further processing downstream, which involves waxing of the shell eggs, packaging of the eggs in flats and stamping the shell eggs with a unique stamp to indicate that the shell eggs are not only pasteurized but also have been sufficiently cooked to be in-shell poached eggs.

As mentioned, the raw side of the facility is separated by a wall 22 from the post-pasteurized side. The pasteurized, in-shell poached eggs are placed into shipping boxes immediately after stamping, sealed using tape and plastic wrapper, and stored in a designated cooler (<45° F. until shipment).

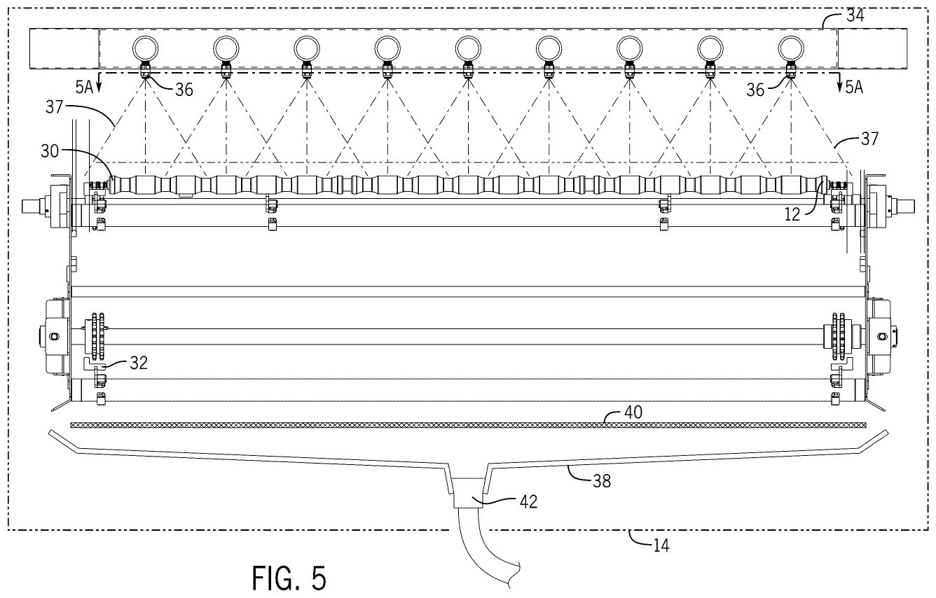

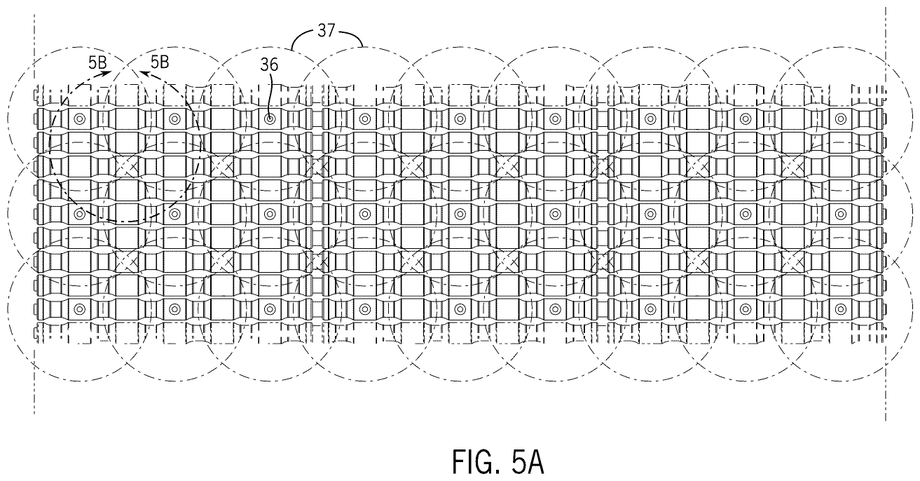

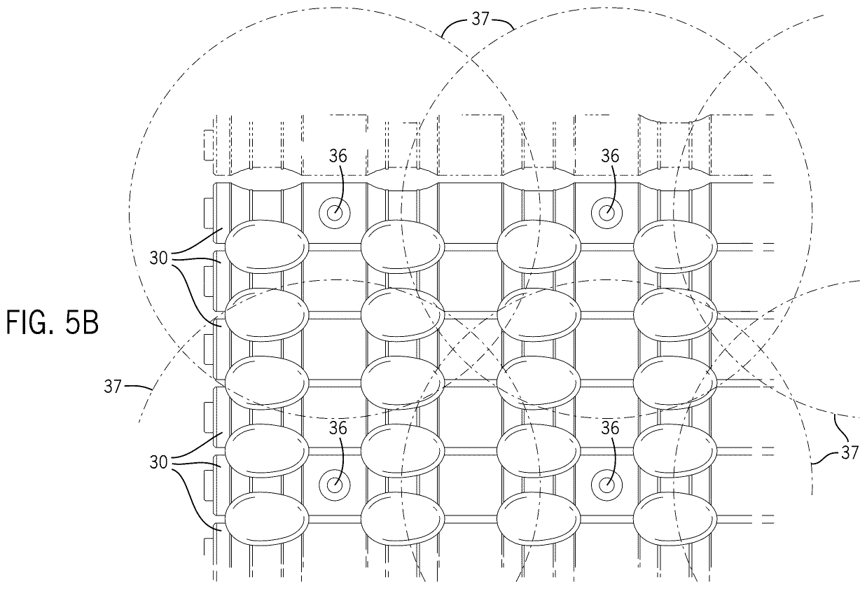

Referring to FIG. 5, the sprayer nozzles 36 are located in rows above the upper run 30 of the conveyor 12 and transverse to the direction of the conveyor 12 moving through the tunnel 14. Each spray nozzle 36 desirably outputs a spray that forms an overlapping spray pattern with the spray from the adjacent spray nozzle 36, see also FIG. 5A. In FIGS. 5 and 5A, there are locations on the contoured roller conveyor 12 for eighteen (18) shell eggs across the conveyor. There are nine (9) spray nozzles, and as mentioned the spray patterns from the nozzles overlap before reaching the expected top of the rotating shell eggs (see FIG. 5B) to form a continuous shower such that the shell eggs transported on the conveyor are continuously showered with heated water. The distance between the rows of sprayer nozzles and the distance between the sprayers in each row are such that the spray pattern covers the entire region through which the shell eggs pass on the conveyor under the spray nozzles. In the disclosed embodiment, the nozzles are placed 7 inches above the contoured rollers on the upper run 30 of the conveyor 12 so that the spray travels approximately 6 inches downward from the respective spray nozzle 36 to the expected location of the top surface of the shell eggs. Of course, the size of the shell eggs varies. Accordingly, the spray nozzles are preferably spaced and set at a height above the conveyor rollers that will ensure spray overlap at the specified spray angle even for XLarge or Jumbo-sized eggs. The spray nozzles in each row are attached to a manifold distribution pipe 34 and spaced apart at e.g., 6 inches. The manifold distribution pipes 34 are spaced apart in parallel rows at e.g., 6 inches. This configuration ensures a continuous overlapping spray pattern covering all of the shell eggs moving through the tunnel on the upper run 30 of the conveyor 12. The desired flow rate of the sprayed water for the overall described system is 2600 to 3600 gallons/minute (650-900 gallons/minutes for each zone). It is possible to change the flow rate within the tolerances of the respective spray nozzles 36 to maintain complete overlapping coverage. Within these ranges, it may be helpful to adjust the flow rate in zone 1 higher to reduce the temperature differential that needs to be addressed when reheating, while reducing the flow rate in the downstream zones where the system only needs to maintain the yolk at the target pasteurization temperature and does not need to heat the entire egg up to the target pasteurization temperature.

FIG. 5 also shows a catch basin 38 underneath conveyor 12. There is a separate catch basin 38 for each zone of the system 10. An optional screen 40 is located in the catch basin 38 which can be removed in order to clean large sediment such as may occur when there is a broken egg. The catch basin 38 has an outlet 42. There is a fine filter in the outlet line. The filtered water from catch basin 38 is combined with make-up water and is recirculated and reheated.

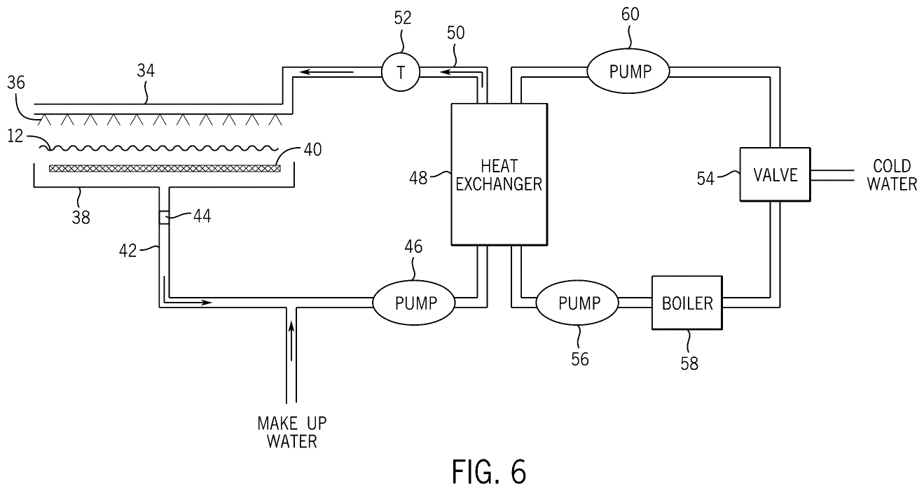

Referring to FIG. 6, the recaptured water in pipe 42 from the catch basin 38 is filtered with a fine filter 44 and is circulated by pump 46 to a heat exchanger 48. Make up water is combined with the recirculated water in pipe 42 leading to the pump 46. The spray water heating loop exits the heat exchanger 48 heated to the desired temperature to spray (e.g. 134.5° F. or 160 OF depending on the zone) and the heated water is distributed through pipe 50 to the sprayer distribution pipes 34. There is a temperature sensor 52 in line 50 to thermostatically control the temperature of the water being supplied to the spray nozzles 36. The pump 46 has a constant flow rate so that the flow rate through the spray nozzles 36 does not fluctuate. The temperature sensor 52 provides a signal that is used by a zone controller to adjust the flowrate of a variable speed pump 60 in the boiler loop, and control the flow rate of the water inputting the heat exchanger 48 via boiler loop. A pump 56 pump waters through the boiler 58, and then through the valve 54. The valve 54 is thermostatically controlled to maintain the temperature at the inlet of the heat exchanger 48 on the boiler side at the desired temperature. The speed of pump 60 is controlled in order to change the amount of heat transferred to the water flowing through the sprayer side of the heat exchanger 48.

As mentioned above, the system 10 is operated so that water is sprayed in Zones 1-3 at 134.5° F. for 6 minutes in each of the three zones and a total of eighteen (18) minutes, which is immediately followed by spraying water in Zone 4 at 160° F. for 6 minutes. FIG. 7 is a photograph of a pasteurized, in-shell poached eggs prepared according to the process described in Example 2. The egg in the photograph of FIG. 7 was cracked open prior to being warmed for consumption. As can be seen in FIG. 7, the cracked egg is on a plate with the yolk sitting in a pocket of coagulated albumen with a thin film of egg white covering the yolk, resembling a typical poached egg. Of course, after pasteurization and cooking at the plant, the in-shell poached eggs are refrigerated prior to and during distribution. To prepare the in-shell poached eggs for consumption in the kitchen, the eggs are cracked and warmed, but there is no need to further cook the eggs on site.

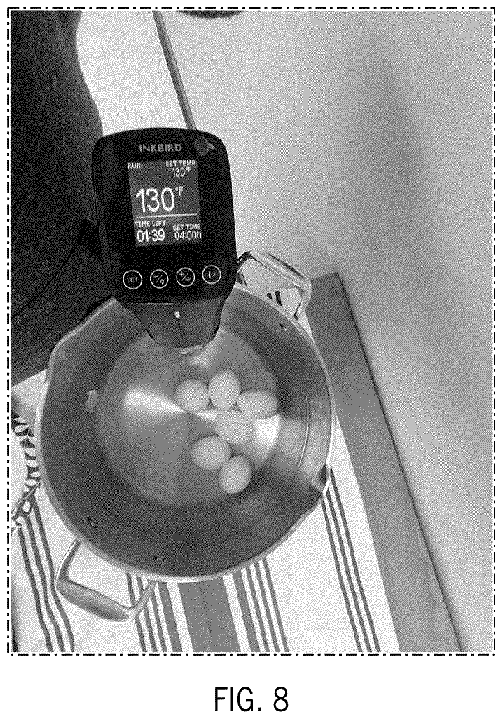

There are several methods of heating the in-shell poached eggs, including heating multiple eggs in water at a low temperature (e.g., 130° F.) for up to 4 hours so that the eggs are ready to use on demand. FIG. 8 is a photograph of in-shell poached eggs being warmed in shell using a sous vide method, with the water held at e.g. 130° F.

Alliteratively, in-shell poached egg can be cracked on to a skillet, preferably with some water, warmed and removed with a spatula. Or, the in-shell poached egg can be put in simmering water within the shell for about 2.5 minutes, or cracked into boiling water and removed with a slotted spoon, or even cracked and placed in a dish of water and put in a microwave for 1-2 minutes depending on the heating efficient of the microwave oven. Since the eggs are not meant to be cooked during the warming process, the quality of the resulting product is consistent.

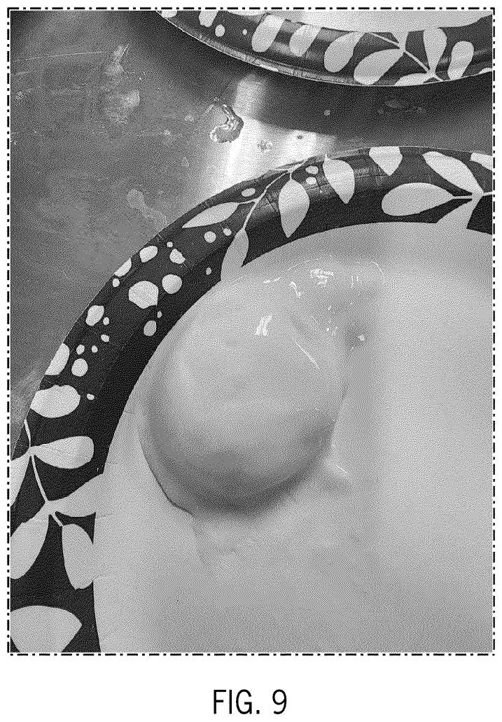

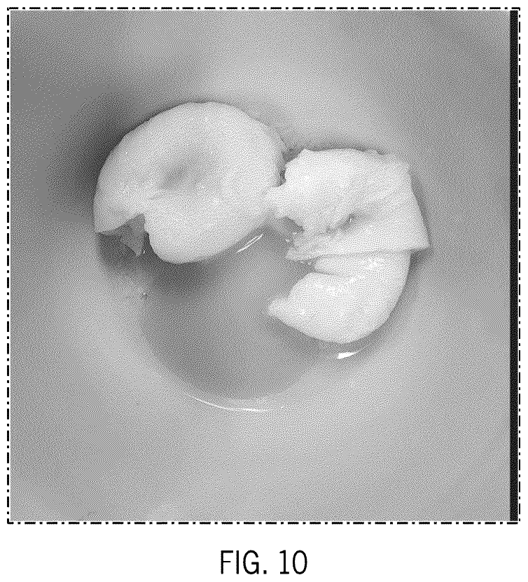

FIG. 9 is a photograph of a cracked, in-shell poached egg after it has been warmed in the shell using the sous vide method as shown in FIG. 8 and cracked onto a plate. FIG. 10 is a photograph of exemplary warmed, in-shell poached eggs cracked into a bowl and cut open to show running yolks.

What is claimed is:

1. A pasteurized, in-shell poached egg having an albumen which has been sufficiently cooked in the shell such that when the egg is cracked onto a plate the egg has characteristics of a conventional poached egg without further cooking, wherein the egg has an albumen that is cooked and whitened and a yolk that remains substantially liquid, the heat treatment to the in-shell egg being sufficient to achieve at least a 5-log reduction of Salmonella Enteritidis throughout the entire yolk and albumen, wherein when the pasteurized, in-shell poached egg is cracked and placed on a flat surface the albumen settles on the flat surface around the yolk which sits in a pocket in the albumen with a layer of coagulated albumen over the yolk and the yolk otherwise sitting higher than the remaining portions of the albumen.

2. The pasteurized, in-shell poached egg recited in claim 1 wherein the heat treatment is implemented by spraying heated water onto the shell egg as it rotates and is moved on a conveyor through a tunnel, and the sprayed heated water is heated to different temperatures in at least two different zones as the shell moves through the tunnel on the conveyor.

3. The pasteurized, in-shell poached egg recited in claim 2 wherein the initial temperature of the water being sprayed is set to 134.5 F and 160 F in the final zone of heat treatment.

4. The pasteurized, in-shell poached egg recited in claim 1 wherein after heat treating the pasteurized, in-shell poached egg is refrigerated, and warmed for consumption.

5. A method of making a pasteurized, in-shell poached egg comprising the steps of:
providing a heat treatment tunnel having multiple zones extending from an inlet to an outlet;
providing a roller conveyor extending through in the tunnel, the roller conveyer including a plurality of rollers to hold and rotate shell eggs as the conveyor moves the shell eggs through the multiple zones in the tunnel;
providing a plurality of sprayers located above the roller conveyor which spray heated water down on rotating shell eggs on the roller conveyer as the conveyor moves the shell eggs through the multiple zones in the tunnel;
placing raw unpasteurized shell eggs on the roller conveyor to enter the tunnel through the tunnel inlet;
rotating the shell eggs and moving the shell eggs through one or more initial zones of the tunnel and spraying water heated to a first temperature on the rotating shell eggs being moved through said one or more initial zones of the tunnel;
continuing to rotate the shell eggs and moving the shell eggs through one or more final zones of the tunnel and spraying water heated to a second temperature on the rotating shell eggs being moved through said one or more final zones of the tunnel;
wherein the temperatures of the heated water sprayed from the plurality of sprayers and the time duration of the respective spraying is sufficient to ensure that the yolk of the rotating shell eggs are pasteurized to achieve at least a statistical 5 log reduction of Salmonella Enteritidis that may have been present in the yolk in the shell eggs, and further wherein the total heat treatment results in the shell eggs having an albumen cooked and whitened and a yolk that remains substantially liquid, and when the pasteurized, in-shell poached egg is cracked and placed on a flat surface the albumen settles on the flat surface around the yolk which sits in a pocket in the albumen with a layer of coagulated albumen over the yolk and the yolk otherwise sits higher than the remaining portions of the albumen.

6. The method of making a pasteurized, in-shell poached egg recited in claim 5 wherein the temperature of the water sprayed in the one or more initial zones of the tunnel is about 134 F and the shell eggs are in the one or more initial zones of the tunnel for about 18 minutes, and the temperature of the water sprayed in the one or more final zones of the tunnel is about 160 F and the shell eggs are in the one or more final zones of the tunnel for about 6 minutes.

7. A method of making a pasteurized, in-shell poached egg comprising the steps of:
heat treating a raw unpasteurized shell egg with heated water held at a first temperature for a first predetermined time duration, the combination of the first temperature and the first predetermined time duration being selected to raise the temperature of the yolk in the shell egg above 128 F without causing the albumen to substantially coagulate; and
continuing heat treatment of the shell egg with heated water held at a second temperature for a second predetermined time duration, said second temperature being higher than the first temperature;
wherein the combination of heat treatment with water at the first temperature and the first predetermined time duration and then at the second temperature and the second predetermined time duration is sufficient to ensure that the yolk of the shell egg is pasteurized to achieve at least a statistical 5 log reduction of Salmonella Enteritidis that may have been present in the yolk in the shell egg, and further wherein the total heat treatment results in the shell egg having an albumen that is cooked and whitened and a yolk which remains substantially liquid, and when the pasteurized, in-shell poached egg is cracked and placed on a flat surface the albumen settles on the flat surface around the yolk sitting in a pocket in the albumen with a layer of coagulated albumen over the yolk and the yolk otherwise sits higher than the remaining portions of the albumen.

8. The method of making a pasteurized, in-shell poached egg as recited in claim 7 wherein heat treating the raw unpasteurized shell egg with heated water held at the first temperature for the first predetermined time duration is accomplished in a first water bath, and heat treating the shell egg with heated water held at the second temperature for the second predetermined time duration is accomplished in a second water bath.

9. The method of making a pasteurized, in-shell poached egg as recited in claim 7 wherein the first temperature is approximately 134.5 F and the first predetermined time duration is approximately 18 minutes, and the second temperature is approximately 160 F and the second predetermined time duration is approximately 6 minutes.
